(19) United States
(12) Patent Application Publication
(10) Pub. No.: US 2023/0135410 A1
(43) Pub. Date: May 4, 2023

(54) AUTOMATIC BUCKET ASSIGNMENT IN BUCKET EXPERIMENTS METHOD AND APPARATUS

(71) Applicant: YAHOO AD TECH LLC, Dulles, VA (US)

(72) Inventors: Yan HE, Milpitas, CA (US); Miao CHEN, Sunnyvale, CA (US); Wai Lim CHOI, San Jose, CA (US); Lin YU, Cupertino, CA (US); Chandrashekhar SHAW, San Jose, CA (US); Donald McLEAN, Conifer, CO (US); Mahendrasinh JADAV, San Jose, CA (US)

(21) Appl. No.: 17/512,773

(22) Filed: Oct. 28, 2021

(51) Int. Cl. G06Q 30/02; G06F 16/22

(52) U.S. Cl. CPC G06Q 30/0203; G06F 16/2255; G06Q 30/0201

(57) ABSTRACT

Techniques for assigning users to buckets for use in bucket experiments are disclosed. Disclosed systems and methods provide systems and methods for making automatic bucket assignments using Nearest Neighbor Matching (NNM). In one embodiment, an iterative approach is used in assigning users to buckets, such that in a given iteration selected users are assigned to a number of buckets, the selected users being an initial user selected from a pool of users and other users selected using pairwise distances associated with the initial user and the other users.

### FIELD OF THE DISCLOSURE

The present disclosure relates to improvements to validating sampling selections in bucket, or variant, testing for use with user experience research computing systems, such as and without limitation online user experience research testing computing systems.

### BACKGROUND

One methodology currently used in user experience research computing systems is a randomized experiment in which users are assigned to different groups, or buckets. For example, A/B testing refers to a testing approach in which users are assigned to one of a number of different buckets, e.g., an “A” bucket or a “B” bucket. Typically, users assigned to one bucket are exposed to a different experience than users assigned to another bucket. One or more metrics (e.g., page views, clicks, return visits, etc.) can be used to measure users' “reaction” to each experience. To further illustrate, one experience in an A/B test can be a control version (e.g., a current web page) and another experience can be a variant of the control version, or variant version. Typically, the variant version varies one aspect, or variable, of the control version so that metrics associated with the control version can be compared with metrics associated with the variant version.

A/B testing can be useful in understanding user engagement and satisfaction with features of a user interface (e.g., a web page, mobile application display or some portion thereof). Using this example, users assigned to the A bucket, which can be referred to as a control bucket, or group, can be exposed to a control version (e.g., an existing version) of the user interface and users assigned to the B bucket, which can be referred to as a variant bucket or group, can be exposed to a variant user interface—a variant of the user interface presented to the control group. Typically, the variant user interface includes a single variant from the control user interface, but it may include multiple differences from the control group's user interface. The reaction of the control and variant user groups can be obtained (e.g., explicit feedback, implicit feedback or some combination) and used in determining whether the differences included in the variant are detrimental.

In an ideal A/B testing scenario, users would be randomly selected such that the resulting user groups, each corresponding to a bucket, are similar enough, or statistically equal, or equal on average. By minimizing the differences between the user groups, or balancing the group populations, differences in the obtained reactions of the groups are more likely to be attributable to the differences between the control and variant experiences. The greater the imbalance, the less confidence there is in the obtained reactions, and the more difficult it becomes to isolate the impact of the variable(s) being tested. With minimal imbalance, differences in the observed reactions are more likely to be attributable to the differences between the variants.

Accordingly, it is important that the different groups or buckets are balanced.

### SUMMARY

The present disclosure provides novel systems and methods for automatic bucket assignment using Nearest Neighbor Matching (NNM). Embodiments of the present disclosure provide a balanced approach for assigning users to buckets for use in bucket experiments. Embodiments of the present disclosure provide a mechanism for balancing bucket assignments and validating matches among users being assigned to buckets as the users are being assigned to the buckets.

Presently, bucket assignments are made and a validation process performed after bucket assignment is completed is used to validate whether or not the bucket assignments are balanced prior to using the bucket assignments in a real experiment. With this approach, a pre-testing validation is conducted before proceeding to a real experiment (i.e., the actual testing phase).

One example of a pre-testing validation is referred to herein as A/A validation. Using this bucket validation approach, users are assigned to buckets, and each bucket is then exposed to the same experience (e.g., the same user interface display). Then, a number of reaction measures, or metrics, can be analyzed to determine the degree to which the buckets of users reacted differently to the same experience. Ideally, there should be minimal difference in the metrics obtained from each bucket if the buckets are balanced. This approach typically can use more than the number of buckets needed for the experiment, such that the buckets determined to have minimal differences (e.g., the buckets identified as being more balanced with similar users than other buckets) can be selected as the buckets to be used in an actual experiment, e.g., an A/B experiment.

A problem with the A/A validation approach of validating bucket assignments is that it requires considerable time and effort prior to actually conducting the A/B experiment. The A/A validation approach requires an A/A test in which the buckets are exposed to the same experience and post-A/A test analysis on the part of scientists/analysts to review and evaluate the bucket assignments before an A/B experiment can be conducted. The added time and effort is a barrier to quick product development.

Another bucket validation approach, referred to herein as the ready-to-use A/A methodology, uses historical data to calculate a number of metrics which are then used to identify a homogeneous pool of users to be used in bucket assignment. The homogeneous pool of users is identified by discarding the users corresponding to the extreme values for each metric. The remaining pool of users are randomly assigned to the experiment buckets. This process of randomly assigning users to buckets can be referred to as traffic splitting. While the ready-to-use A/A methodology improves over the A/A validation discussed above, a 5-10% imbalance rate still exists for the experiments opened using the ready-to-use A/A methodology. In addition, the practice of discarding users with extreme metric values can result in eliminating a considerable number of users from tests—e.g., approximately 20-30% traffic volume (e.g., website visitors). The loss in traffic volume reduces the pool of users available for assignment to buckets. Furthermore, as the number of metrics increases, a greater number of users are discarded, such that an increase in the number of metrics used with the ready-to-use A/A methodology results in a greater loss in traffic volume.

Thus, there is a need for a bucket assignment approach capable of quickly and accurately selecting a balanced set of buckets for experimentation, e.g., A/B experimentation, online experimentation, etc.

An online provider can conduct hundreds of bucket experiments each day. Each bucket experiment uses a number of buckets, each of which comprises a random sample of users. Each bucket experiment typically has a control bucket and one or more test buckets.

In accordance with one or more embodiments, experimentation using buckets can be performed on a multi-layer experimentation platform, each layer of which having one or more experiments. A user can be assigned to one experiment in a layer. Using different layers, a user can be assigned to more than one experiment—one experiment per layer. In a given layer, an experiment can include multiple buckets, and a user can be assigned to one of the buckets. In accordance with one or more embodiments, the automatic bucket validation using Nearest Neighbor Matching (NNM) can be used in a multi-layer experimentation platform with any number of layers, e.g., one or more layers.

In accordance with one or more embodiments, with the multi-layer experimentation platform, a user can be assigned a hash value in a given layer, and can be assigned to a bucket for an experiment in the layer using the user's hash value. By way of a non-limiting example, each layer can have a corresponding hash function and a unique random seed, which can be used to generate a hash value for a user in the layer. Using a unique random seed for each layer allows each user to have a different hash value for each layer. A hash value can be assigned to multiple users in a layer, and multiple hash values can be used in assigning users to a bucket associated with an experiment.

According to some embodiments, the disclosed systems and methods first receive a bucket assignment request. The bucket assignment request can comprise information indicating a number of buckets, the bucket size (e.g., a percentage of users to be assigned to each bucket), a source from which to select the users (e.g., the bucket request can indicate a certain set of users, such as and without limitation visitors to home page or other web property, website, webpage, users of a certain application, etc.)

The disclosed systems and methods then can associate a hash value with each user in a pool of users representing candidates for assignment to a bucket in connection with a bucket experiment. By way of a non-limiting example, candidates can be visitors of a certain website or users of a certain application, etc. In some embodiments, a hash value can be determined for a user using a user identifier associated with the user, a seed value and a hash function. In accordance with one or more embodiments, the seed value can be unique to each layer in a multi-layer experimentation platform. By way of a further non-limiting example, a hash value determined using the hash function can be an integer value within a predetermined range, such as 0 to 999.

The disclosed systems and methods then obtain, for each user in the user pool, a value for each of a number of metrics, or user-related metrics, of interest for an experiment. Some non-limiting examples of user-related metrics that can be used include data associated with users, such as days visited, page views (also referred to herein as classic page views), number of network sessions, and property-level revenue. By way of a further non-limiting example, the disclosed systems and methods then determine, for each user in the user pool, a value for each identified user-related metric using user data associated with a given time period, e.g., the preceding number of days. Continuing with the example provided above, each user can have a days-visited metric value, a page-views metric value, a network sessions metric value and a property-level metric value determined using data about the user's page views, number of sessions, revenue attributable to the user, etc. collected in the preceding number (e.g., 7) days. By way of a non-limiting example, a metric and its corresponding value can be a measure of a user's engagement with a web site, application, etc.

The disclosed systems and methods then determine, for each user in the pool of users, a standardized metric value for each identified metric. By way of a non-limiting example, the standardized metric value, for a user and a given metric value, can be a normalized value determined using the metric value determined for the user, together with a mean and standard deviation determined across the pool of users.

The disclosed systems and methods then determine a distance matrix M using the identified metrics. By way of a non-limiting example, a distance matrix can be a two-dimensional matrix with a number of rows and columns. In accordance with one or more embodiments, the number of rows and columns can be equal, or the same. By way of one non-limiting example, if the number of rows and columns is equal to 1000, the matrix M is a 1000×1000 matrix, and the range of hash values determined in the first step is 0-999. In accordance with one or more embodiments, multiple users can have the same hash value. For example, assuming there are 1,000,000 (one million) users in total and a 0-999 hash value range, each hash value in the hash value range can have 1000 users hashed to the hash value—1000 users can be assigned to each hash value in the hash value range.

While it is possible to control the number of users assigned to each hash value such that each hash value has exactly 1000 assigned users in the above example, it is not necessary to do so. In accordance with one or more embodiments, assuming the 0-999 hash value range in the above example, it is possible for one hash value to have more or less than 1000 users. A user that visits a web site can have a 1/1000^{th} chance of being assigned to each of the values in the hash value range. If 1,000,000 (one million) users visit the website, each hash value can have 1000 users on average, such that it is possible for one hash value to have less than 1000 users (e.g., 998users) and another hash value to have more than 1000 users (e.g., 1001 users).

In accordance with one or more embodiments, each cell in the matrix M has a corresponding pairwise distance associated with a pair of hash values, which can be determined using at least one aggregate standardized metric value associated with each hash value in the pair. For example, using i as a row index and j as a column index, an element Mᵢⱼ represents the pairwise distance (e.g., Euclidean distance) determined using the pair of aggregate standardized metric values associated with row i and column j in the matrix M. In accordance with one or more embodiments, the aggregate standardized metric value corresponding to row i (or column j) can be an average of the standardized metric values corresponding to the users associated with row i or column j. For example, with respect to row i, the aggregate standardized metric value can be the average of the standardized metric values of the users associated with a hash value equal to i. Where hash value i and hash value j are equal indicating the set of users with the same hash value, the corresponding cell of the matrix M can have a value of zero for the pairwise distance.

The disclosed systems and methods can then use matrix M and iteratively assign a number of users from the user pool to a set of buckets (e.g., a requested number of buckets) until a determined bucket size (e.g., a certain percentage of users) is reached for each of the buckets in the set.

In accordance with disclosed embodiments, users can be assigned to the set of buckets (e.g., in connection with a given bucket experiment) using a number of iterations in the iterative process. In each iteration, an initial hash value can be randomly selected from the set of available hash values. A user from the user pool that has not yet been assigned to a bucket during the iterative process and that is associated with the initial hash value can be randomly selected as an initial user in the current iteration. In the first iteration, all of the users in the user pool having the initial hash value as an assigned hash value can be available to be selected as the initial user. After being selected, the initial user is removed from the set of available users for purposes of selecting other users in the current and subsequent iterations. As discussed below, in the current iteration, other users can then be selected from the set of available users in the user pool using the initial hash value's pairwise distances indicated in matrix M. Each pairwise distance being considered is associated with the initial hash value.

In accordance with one or more embodiments, the initial hash value and the pairwise distances associated with the initial hash value can be used to identify a number of other hash values corresponding to the lowest of the pairwise distances (as compared with other unselected pairwise distances) associated with the initial hash value. By way of a non-limiting example, assuming that the number of buckets to which users can be assigned in an iterative process is equal to three, the two lowest pairwise distances associated with the initial hash value can be identified and two users corresponding to the two hash values with the lowest pairwise distances can be identified as the other users (in addition to the initial user) selected for assignment to the three buckets. The selected users comprising the initial user and the other randomly-selected users can each be assigned (e.g., randomly assigned) to one of the buckets (e.g., one of the three buckets). Each user assigned to a bucket becomes unavailable for subsequent iterations, and the bucket assignment continues in this manner until a predetermined bucket size is reached for each bucket.

The automatic A/A validation using a Nearest Neighbor Matching (NNM) disclosed herein improves bucket balance, or A/A balance, and reduces the false positive rate for the metrics of interest. Automatic bucket validation using a Nearest Neighbor Matching (NNM) disclosed herein improves over prior approaches. Since there is no need to perform A/A testing, the automatic bucket validation using NNM saves significant time and effort over A/A testing. In addition, the automatic bucket validation using NNM disclosed herein can be used with any number of metrics whose values (e.g., standardized values) can be aggregated into a Euclidean distance to measure pairwise distance between each pair of hash values. Use of pairwise distances facilitates bucket balancing. In addition, the approach can be used regardless of the number of metrics identified for a given experiment as the approach eliminates the need for discarding users with extreme metric values.

It will be recognized from the disclosure herein that embodiments of the instant disclosure provide improvements to a number of technology areas, for example those related to systems and processes that provide user interface displays, including online and application user interface displays. By way of some non-limiting examples, systems and processor can use user interface displays to display content, distribute content, provide recommendations, provide search engine results, etc. The disclosed systems and methods can effectuate increased speed and efficiency in the ways that experimentation buckets can be provided for use in testing efficacies related to different user interface display options, as the disclosed systems and methods, inter alia, automatically assign users to buckets using a NNM methodology. Users are assigned a hash value, a set of standardized metric values is used to determine pairwise distance between each pair of hash values using the set of standardized metrics associated with each hash value's associated users, and an iterative approach is used to make bucket assignment based on pairwise distances determined for the hash values.

In accordance with one or more embodiments, a method is disclosed which includes receiving, at a computing device, a bucket assignment request for a set of buckets to be used in a bucket experiment; associating, via the computing device, each user in a user pool with a hash value of a range of hash values; obtaining, via the computing device, a metric value for each user in the user pool; determining, via the computing device, an aggregate metric value for each hash value in the range of hash values, a respective hash value's aggregate metric value being determined using the metric value obtained for each user associated with the respective hash value; obtaining, via the computing device, a set of pairwise distances, each pairwise distance of the set corresponding to a pair of hash values in the range of hash values, the pairwise distance for the pair of hash values being determined using the aggregate metric values determined for the pair of hash values; determining, via the computing device, user assignments for the set of buckets by assigning a number of users from the user pool to the set of buckets in each of a number of bucket assignment iterations, each bucket assignment iteration comprising: randomly selecting, via the computing device, an initial hash value in the range of hash values; selecting, via the computing device and in the range of hash values, a set of hash values other than the initial hash value using the pairwise distances associated with the initial hash value, each hash value in the set of hash values having an associated pairwise distance with the initial hash value that is less than any unselected pairwise distance associated with the initial hash; randomly selecting, via the computing device, an initial user associated with the initial hash value for inclusion in a set of identified users; randomly selecting, via the computing device, a user associated with each hash value from the set of hash values for inclusion in the set of identified users; randomly assigning, via the computing device, one user from the set of identified users to each bucket of the number of buckets; and removing, via the computing device, the set of identified users from the user pool for any remaining bucket assignment iterations; and providing, via the computing device, the number of buckets to the requester, each bucket of the number having a unique set of users selected from the user pool.

In accordance with one or more embodiments, a non-transitory computer-readable storage medium is provided, the non-transitory computer-readable storage medium tangibly storing thereon, or having tangibly encoded thereon, computer readable instructions that when executed cause at least one processor to perform a method for automatic bucket assignment using Nearest Neighbor Matching (NNM).

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a schematic block diagram illustrating components of an exemplary system in accordance with embodiments of the present disclosure;

FIG. 4 is a flowchart illustrating steps performed in accordance with some embodiments of the present disclosure;

FIG. 5 is a diagram of an exemplary example of a non-limiting embodiment in accordance with some embodiments of the present disclosure;

FIG. 6 is a flowchart illustrating steps performed in accordance with some embodiments of the present disclosure;

FIGS. 7-9 are each a diagram of an exemplary example of a non-limiting embodiment in accordance with some embodiments of the present disclosure; and

FIG. 10 is a block diagram illustrating the architecture of an exemplary hardware device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations. For example, a simple smart phone, phablet or tablet may include a numeric keypad or a display of limited functionality, such as a monochrome liquid crystal display (LCD) for displaying text. In contrast, however, as another example, a web-enabled client device may include a high resolution screen, one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

A client device may include or may execute a variety of possible applications, such as a client software application enabling communication with other devices, such as communicating one or more messages, such as via email, for example Yahoo!® Mail, short message service (SMS), or multimedia message service (MMS), for example Yahoo! Messenger®, including via a network, such as a social network, including, for example, Tumblr®, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing or displaying various forms of content, including locally stored or streamed video, or games (such as fantasy sports leagues). The foregoing is provided to illustrate that claimed subject matter is intended to include a wide range of possible features or capabilities.

The detailed description provided herein is not intended as an extensive or detailed discussion of known concepts, and as such, details that are known generally to those of ordinary skill in the relevant art may have been omitted or may be handled in summary fashion.

The principles described herein may be embodied in many different forms. By way of background, a bucket experiment, which is also referred to as A/B testing, refers to an experiment in which users are assigned to one of a number (e.g., two or more) buckets, or groups, for purposes of comparing user reaction to different experiences. One bucket of users can be exposed to one experience and another group is exposed to a different experience. Bucket experiments are a very effective tool in designing a user interface. One bucket of users can be exposed to one version of the user interface while another one or more buckets can be exposed to a different version of the user interface. Data associated with a number of metrics is then gathered and used to determine whether one of the user interface designs is better than another in terms of user reaction—e.g., improved user engagement and satisfaction relative to the other user interface designs.

It is important to minimize the differences between the user groups assigned to buckets. By achieving balance, differences in the obtained reactions of the groups are more likely to be attributable to the differences between the variable experiences to which the groups are exposed. The greater the imbalance, the less confidence there is in the obtained reactions, and the more difficult it becomes to isolate the impact of the variable(s) being tested. With minimal imbalance, differences in the observed reactions are more likely to be attributable to the differences between the variants.

Current attempts at bucket assignment and balance validation are lacking. For example and in one approach, a pre-experiment validation (or A/A validation) is conducted to validate whether or not an acceptable level of balance has been achieved. In effect, this approach requires a pre-bucket experiment to validate the balance of the bucket assignments before the actual bucket experiment can be conducted.

While the ready-to-use A/A methodology eliminates the need for A/A validation, its technique for achieving balance in bucket assignment using a homogeneous pool eliminates too many users from the pool by discarding users with extreme metric values, and the number of users discarded can increase as metrics are used in obtaining the homogeneous pool. In addition, this approach still results in a 5-10% imbalance rate.

Thus, there is a need for a bucket assignment approach capable of quickly and accurately selecting a balanced set of buckets for experimentation, e.g., A/B experimentation, online experimentation, etc.

As such, the instant disclosure provides a novel solution addressing the immediate demand for an automated system, application and/or platform that automatically assigns users to buckets for bucket experiments. The present disclosure provides novel systems and methods for automatic bucket assignment using Nearest Neighbor Matching (NNM). According to some embodiments, the disclosed systems and methods first receive a bucket assignment request. The bucket assignment request can comprise information indicating a number of buckets, the bucket size (e.g., a percentage of users to be assigned to each bucket), a source from which to select the users (e.g., the bucket request can indicate a certain set of users, such as and without limitation visitors to home page or other web property, website, webpage, users of a certain application, etc.)

The disclosed systems and methods then can associate a hash value with each user in a pool of users representing candidates for assignment to a bucket in connection with a bucket experiment. By way of a non-limiting example, candidates can be visitors of a certain website or users of a certain application, etc. In some embodiments, a hash value can be determined for a user using a user identifier associated with the user, a seed value and a hash function. In accordance with one or more embodiments, the seed value can be unique to each layer in a multi-layer experimentation platform. By way of a further non-limiting example, a hash value determined using the hash function can be an integer value within a predetermined range, such as 0 to 999.

The disclosed systems and methods then obtain, for each user in the user pool, a value for each of a number of metrics, or user-related metrics, of interest for an experiment. Some non-limiting examples of user-related metrics that can be used include data associated with users, such as days visited, page views (also referred to herein as classic page views), number of network sessions, and property-level revenue. By way of a further non-limiting example, the disclosed systems and methods then determine, for each user in the user pool, a value for each identified user-related metric using user data associated with a given time period, e.g., the preceding number of days. Continuing with the example provided above, each user can have a days-visited metric value, a page-views metric value, a network sessions metric value and a property-level metric value determined using data about the user's page views, number of sessions, revenue attributable to the user, etc. collected in the preceding number (e.g., 7) days. By way of a non-limiting example, a metric and its corresponding value can be a measure of a user's engagement with a web site, application, etc.

The disclosed systems and methods then determine, for each user in the pool of users, a standardized metric value for each identified metric. By way of a non-limiting example, the standardized metric value, for a user and a given metric value, can be a normalized value determined using the metric value determined for the user, together with a mean and standard deviation determined across the pool of users.

The disclosed systems and methods then determine a distance matrix M using the identified metrics. By way of a non-limiting example, a distance matrix can be a two-dimensional matrix with a number of rows and columns. In accordance with one or more embodiments, the number of rows and columns can be equal, or the same. By way of one non-limiting example, if the number of rows and columns is equal to 1000, the matrix M is a 1000×1000 matrix, and the range of hash values determined in the first step is 0-999. In accordance with one or more embodiments, multiple users can have the same hash value. For example, assuming there are 1,000,000(one million) users in total and a 0-999 hash value range, each hash value in the hash value range can have 1000 users hashed to the hash value—1000 users can be assigned to each hash value in the hash value range.

In accordance with one or more embodiments, assuming the 0-999 hash value range in the above example, it is possible for one hash value to have more or less than 1000 users. A user that visits a web site can have a 1/1000^{th} chance of being assigned to each of the values in the hash value range. If 1,000,000(one million) users visit the website, each hash value can have 1000 users on average, such that it is possible for one hash value to have less than 1000 users (e.g., 998users) and another hash value to have more than 1000 users (e.g., 1001 users).

In accordance with one or more embodiments, each cell in the matrix M has a corresponding pairwise distance associated with a pair of hash values, which can be determined using an aggregate standardized metric value associated with each hash value in the pair. For example, using i as a row index and j as a column index, an element Mᵢⱼ represents the pairwise distance (e.g., Euclidean distance) determined using the pair of aggregate standardized metric values associated with row i and column j in the matrix M. In accordance with one or more embodiments, the aggregate standardized metric value corresponding to row i or column j can be an average of the standardized metric values corresponding to the users associated with row i or column j. For example, with respect to row i, the aggregate standardized metric value can be the average of the standardized metric values of the users associated with a hash value equal to i. Where hash value i and hash value j are equal indicating the set of users with the same hash value, the corresponding cell of the matrix M can have a value of zero for the pairwise distance.

The disclosed systems and methods can then use matrix M and iteratively assign a number of users from the user pool to a set of buckets (e.g., a requested number of buckets) until a determined bucket size (e.g., a certain percentage of users) is reached for each of the buckets in the set.

In accordance with disclosed embodiments, users can be assigned to the set of buckets (e.g., in connection with a given bucket experiment) using a number of iterations in the iterative process. In each iteration, an initial hash value can be randomly selected from the set of available hash values. A user from the user pool that has not yet been assigned to a bucket during the iterative process and that is associated with the initial hash value can be randomly selected as an initial user in the current iteration. In the first iteration, all of the users in the user pool having the initial hash value as an assigned hash value can be available to be selected as the initial user. After being selected, the initial user is removed from the set of available users for purposes of selecting other users in the current and subsequent iterations. As discussed below, in the current iteration, other users can then be selected from the set of available users in the user pool using the initial hash value's pairwise distances indicated in matrix M. Each pairwise distance being considered is associated with the initial hash value.

In accordance with one or more embodiments, the initial hash value and the pairwise distances associated with the initial hash value can be used to identify a number of other hash values corresponding to the lowest of the pairwise distances (as compared with other unselected pairwise distances) associated with the initial hash value. By way of a non-limiting example, assuming that the number of buckets to which users can be assigned in an iterative process is equal to three, the two lowest pairwise distances associated with the initial hash value can be identified and two users corresponding to the two hash values with the lowest pairwise distances can be identified as the other users (in addition to the initial user) selected for assignment to the three buckets. The selected users comprising the initial user and the other randomly-selected users can each be assigned (e.g., randomly assigned) to one of the buckets (e.g., one of the three buckets). Each user assigned to a bucket becomes unavailable for subsequent iterations, and the bucket assignment continues in this manner until a predetermined bucket size is reached for each bucket.

The automatic A/A validation using a Nearest Neighbor Matching (NNM) approach disclosed herein improves bucket balance, or A/A balance, and reduces the false positive rate for the metrics of interests. Automatic bucket validation using a Nearest Neighbor Matching (NNM) approach disclosed herein improves over A/A testing described above. Since there is no need to perform A/A testing, the automatic bucket validation using NNM saves significant time and effort over A/A testing. In addition, the automatic bucket validation using NNM disclosed herein can be used with any number of metrics whose values (e.g., standardized values) can be aggregated into a Euclidean distance to measure pairwise distance between each pair of hash values. Use of pairwise distances facilitates bucket balancing. In addition, the approach can be used regardless of the number of metrics identified for a given experiment as the approach eliminates the need for discarding users with extreme metric values.

It will be recognized from the disclosure herein that embodiments of the instant disclosure provide improvements to a number of technology areas, for example those related to systems and processes that provide user interface displays, including online and application user interface displays. By way of some non-limiting examples, systems and processor can use user interface displays to display content, distribute content, provide recommendations, provide search engine results, etc. The disclosed systems and methods can effectuate increased speed and efficiency in the ways that experimentation buckets can be provided for use in testing efficacies related to different user interface display options, as the disclosed systems and methods, inter alia, automatically assign users to buckets using a NNM methodology. Users are assigned a hash value, a set of standardized metric values is used to determine pairwise distance between each pair of hash values using the set of standardized metrics associated with each hash value's associated users, and an iterative approach is used to make bucket assignment based on pairwise distances determined for the hash values.

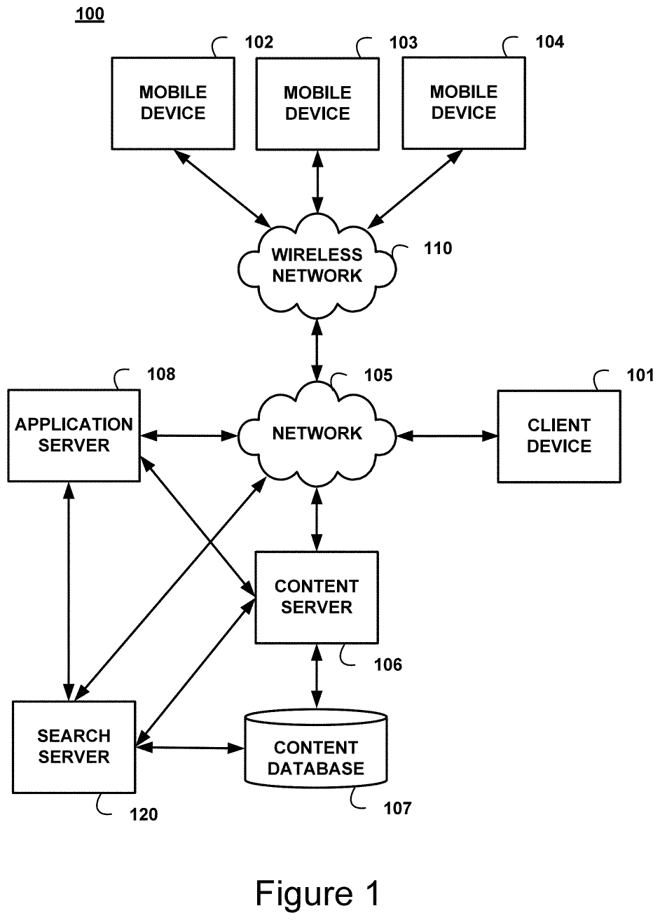

Certain embodiments will now be described in greater detail with reference to the figures. The following describes components of a general architecture used within the disclosed system and methods, the operation of which with respect to the disclosed system and methods being described herein. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as, by way of non-limiting examples, content server 106, application (or “App”) server 108, search server 120 and advertising (“ad”) server (not shown).

One embodiment of mobile devices 102-104 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, smart watch, tablet computers, phablets, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and an HD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, searching for, viewing and/or sharing photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-104 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Network 105 is configured to couple content server 106, application server 108, or the like, with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, QUIC (Quick UDP Internet Connection), DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within or accessible to an electronic social networking site. A social network refers generally to an electronic network of individuals, such as acquaintances, friends, family, colleagues, or co-workers, which are coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, phablets, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site or service, such as streaming media site/service (e.g., YouTube®), an email platform or social networking site, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, streaming and/or downloading media services, search services, email services, photo services, web services, social networking services, news services, third-party services, audio services, video services, instant messaging (IM) services, SMS services, MMS services, FTP services, voice over IP (VOIP) services, or the like. Such services, for example a video application and/or video platform, can be provided via the application server 108, whereby a user is able to utilize such service upon the user being authenticated, verified or identified by the service. Examples of content may include images, text, audio, video, or the like, which may be processed in the form of physical signals, such as electrical signals, for example, or may be stored in memory, as physical states, for example.

An ad server comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is advertisers will pay higher advertising rates when they believe their ads are being placed in or along with highly relevant content that is being presented to users. Reductions in the time needed to quantify a high quality ad placement offers ad platforms competitive advantages. Thus higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108 and 120 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In some embodiments, users are able to access services provided by servers 106, 108 and/or 120. This may include in a non-limiting example, authentication servers, search servers, email servers, social networking services servers, SMS servers, IM servers, MMS servers, exchange servers, photo-sharing services servers, and travel services servers, via the network 105 using their various devices 101-104. In some embodiments, applications, such as a streaming video application (e.g., YouTube®, Netflix®, Hulu®, iTunes®, Amazon Prime®, HBO Go®, and the like), blog, photo storage/sharing application or social networking application (e.g., Flickr®, Tumblr®, and the like), can be hosted by the application server 108 (or content server 106, search server 120 and the like). Thus, the application server 108 can store various types of applications and application related information including application data and user profile information (e.g., identifying and behavioral information associated with a user). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108, 120, or an ad server or ad network.

Moreover, although FIG. 1 illustrates servers 106, 108 and 120 as single computing devices, respectively, the disclosure is not so limited. For example, one or more functions of servers 106, 108 and/or 120 may be distributed across one or more distinct computing devices. Moreover, in one embodiment, servers 106, 108 and/or 120 may be integrated into a single computing device, without departing from the scope of the present disclosure.

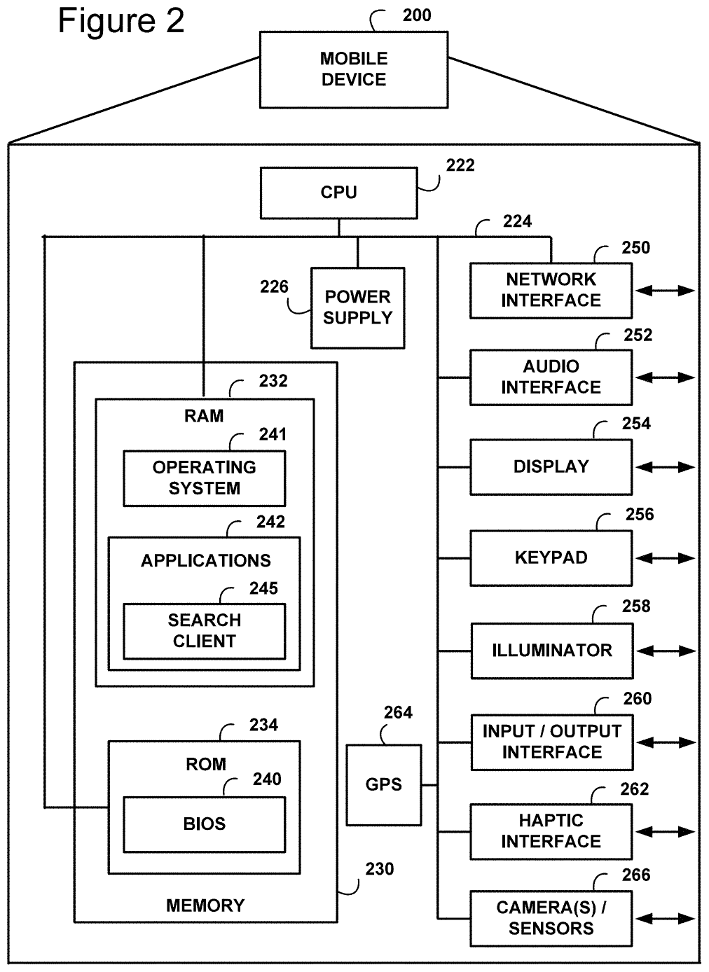

FIG. 2 is a schematic diagram illustrating a client device showing an example embodiment of a client device that may be used within the present disclosure. Device 200 may include many more or less components than those shown in FIG. 2. However, the components shown are sufficient to disclose an illustrative embodiment for implementing the present disclosure. Device 200 may represent, for example, client device 101 and mobile devices 102-104 discussed above in relation to FIG. 1.

As shown in the figure, device 200 includes a processing unit (CPU) 222 in communication with a mass memory 230 via a bus 224. Device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. The positioning of the camera(s)/sensor(s) 266 on device 200 can change per device 200 model, per device 200 capabilities, and the like, or some combination thereof.

Device 200 may optionally communicate with a base station (not shown), or directly with another computing device. Network interface 250 includes circuitry for coupling device 200 to one or more networks, and is constructed for use with one or more communication protocols and technologies as discussed above.

Optional GPS transceiver 264 can determine the physical coordinates of device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of device 200 on the surface of the Earth. In an embodiment, device 200 may through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of device 200. The mass memory also stores an operating system 241 for controlling the operation of device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by device 200 to store, among other things, applications 242 and/or other data. For example, data stores may be employed to store information that describes various capabilities of device 200. The information may then be provided to another device based on any of a variety of events, including being sent as part of a header during a communication, sent upon request, or the like. At least a portion of the capability information may also be stored on a disk drive or other storage medium (not shown) within device 200.

Applications 242 may include computer executable instructions which, when executed by device 200, transmit, receive, and/or otherwise process audio, video, images, and enable telecommunication with a server and/or another user of another client device. Other examples of application programs or “apps” in some embodiments include browsers, calendars, contact managers, task managers, transcoders, photo management, database programs, word processing programs, security applications, spreadsheet programs, games, search programs, and so forth. Applications 242 may further include search client 245 that is configured to send, to receive, and/or to otherwise process a search query and/or search result using any known or to be known communication protocols. Although a single search client 245 is illustrated it should be clear that multiple search clients may be employed. For example, one search client may be configured to enter a search query message, where another search client manages search results, and yet another search client is configured to manage serving advertisements, IMs, emails, and other types of known messages, or the like.

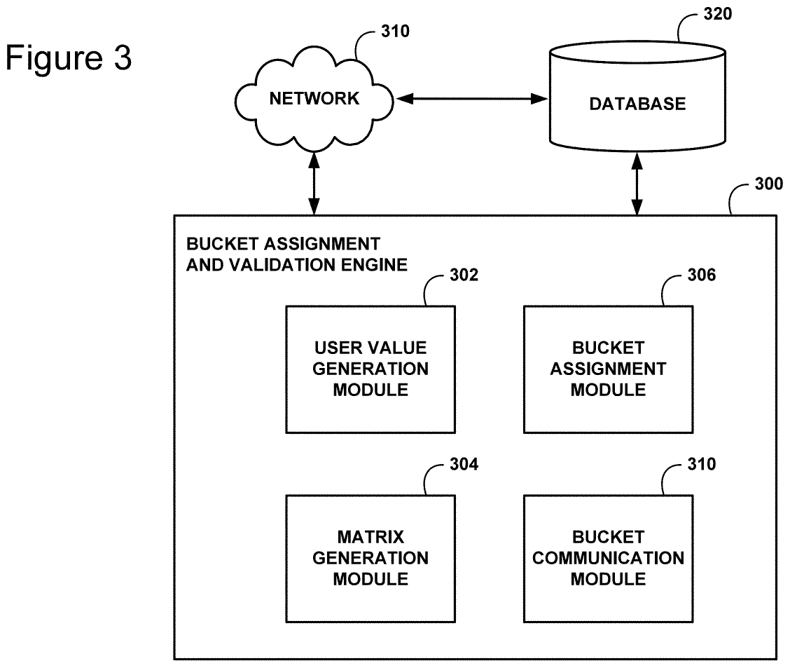

FIG. 3 is a block diagram illustrating the components for performing the systems and methods discussed herein. FIG. 3 includes a bucket assignment and validation (BAV) engine 300, network 310 and database 320. The BAV engine 300 can be a special purpose machine or processor and could be hosted by an application server, content server, social networking server, web server, search server, content provider, email service provider, ad server, user's computing device, and the like, or any combination thereof.

According to some embodiments, the BAV engine 300 can be embodied as a stand-alone application that executes on a computing device, user computing device, server computing device, etc. In some embodiments, the BAV engine 300 can function as an application installed on the computing device, and in some embodiments, such application can be a web-based application accessed by the computing device over a network.

The database 320 can be any type of database or memory, and can be associated with a server computing device on a network (such as and without limitation a web server, application server, etc.,) or a user's device. Database 320 comprises a dataset of data and metadata associated with local and/or network information related to users, services, applications, content (e.g., video) and the like. Such information can be stored and indexed in the database 320 independently and/or as a linked or associated dataset. It should be understood that the data (and metadata) in the database 320 can be any type of information and type, whether known or to be known, without departing from the scope of the present disclosure.

In some embodiments, the database 320 can include, for purposes of creating buckets, or groups of users for bucket experiments, user data including metric data (e.g., historical metric data, standardized matric values, etc.), matrix data (e.g., pairwise distances), bucket assignments, layer identification, layer information (e.g., seed value), user hash values, per layer user hash values), bucket ID or name, etc.

According to some embodiments, database 320 can store other data about users, e.g., user data. According to some embodiments, the stored user data can include, but is not limited to, information associated with a user's profile, user interests, user behavioral information, user attributes, user preferences or settings, user demographic information, user location information, user biographic information, and the like, or some combination thereof. In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 320 can be any type of information related to a user, content, a device, an application, a service provider, a content provider, whether known or to be known, without departing from the scope of the present disclosure.

The network 310 can be any type of network such as, but not limited to, a wireless network, a local area network (LAN), wide area network (WAN), the Internet, or a combination thereof. The network 310 facilitates connectivity of the BAV engine 300, and the database of stored resources 320. Indeed, as illustrated in FIG. 3, the BAV engine 300 and database 320 can be directly connected by any known or to be known method of connecting and/or enabling communication between such devices and resources.

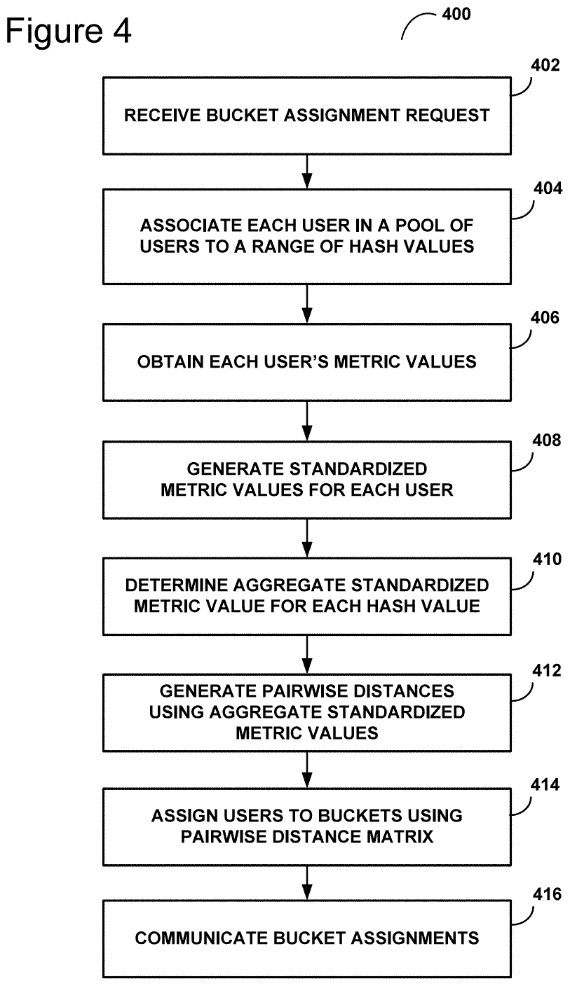

The principal processor, server, or combination of devices that comprises hardware programmed in accordance with the special purpose functions herein is referred to for convenience as BAV engine 300, and includes user value generation module 302, matrix generation module 304, bucket assignment module 306, and bucket communications module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed with reference to FIG. 4.

As discussed in more detail below, the information processed by the BAV engine 300 can be supplied to the database 320 in order to ensure that the information housed in the database 320 is up-to-date as the disclosed systems and methods leverage real-time information, as discussed in more detail below.

FIG. 4 provides a process flow overview in accordance with one or more embodiments of the present disclosure. Process 400 of FIG. 4 details steps performed in accordance with exemplary embodiments of the present disclosure for automatically assigning and validating buckets using NNM (Nearest Neighbor Matching). According to some embodiments, as discussed herein with relation to FIG. 4, the process involves automatically assigning users to a number, n, buckets in accordance with pairwise distances determined for pairs of hash values in a range of hash values. Such assignment and validation involves, associating each user in a user pool with a hash value in the range of hash values, using metric values (e.g., standardized metric values) of users assigned to a given hash value to determine an aggregate metric value (e.g., an aggregate standardized metric value) corresponding to the hash value, using the aggregate metric values associated with each pair of hash values to determine a pairwise distance for each pair of hash values, using the determined pairwise distances (e.g., pairwise distances stored in a pairwise distance matrix) comprising, for each pair of hash values, the pairwise distance determined for the pair of hash values, and determining user bucket assignments using the pairwise distances determined for the hash value pairings.

In accordance with one or more embodiments, user bucket assignments can be an iterative process. Each iteration can involve randomly selecting an initial hash value in the range of hash values and randomly selecting an initial user associated with the initial hash value for including in a set of identified users identified in the current iteration. A number of other users can be selected for inclusion in the set of identified users by selecting a set of hash values other than the initial hash value using the pairwise distances associated with the initial hash value, each hash value in the set of selected hash values having an associated pairwise distance with the initial hash value that is less than any unselected pairwise distance associated with the initial hash, and then selecting a user associated with each hash value from the set of selected hash values for inclusion in the set of identified users. One user from the set of identified users can be randomly assigned to each bucket of the number, n. buckets, as discussed in more detail below.

At step 402, which can be performed by the BAV engine 300, a bucket assignment request is received. The bucket assignment request can comprise information indicating a number of buckets, the bucket size (e.g., a percentage of website visitors, application users, etc. to be assigned to each bucket), a source from which to select the users (e.g., the bucket request can indicate a certain pool of users, such as and without limitation visitors to a specified home page or other web property, website, webpage, users of a certain application, etc.)

At step 404, which can be performed by user value generation module 302, a hash value can be obtained for each user in the user pool. In accordance with one or more embodiments, a hash value can be generated for each user that is a candidate for assignment to a bucket in connection with a bucket experiment using a hash function and a seed value. By way of a non-limiting example, candidates can be visitors of a certain website or users of a certain application, etc. By way of a non-limiting example, a hash value can be generated for a user using a user identifier associated with the user, a seed value and a hash function. By way of a further non-limiting example, the hash value can be an integer value within a predetermined range, such as 0 to 999.

In accordance with one or more embodiments, experimentation using buckets can be performed on a multi-layer experimentation platform, each layer of which having one or more experiments. A user can be assigned to one experiment in a layer. Using different layers, a user can be assigned to more than one experiment—one experiment per layer. In a given layer, an experiment can include multiple buckets, and a user can be assigned to one of the buckets. In accordance with one or more embodiments, the automatic bucket validation using Nearest Neighbor Matching (NNM) can be used in a multi-layer experimentation platform with any number of layers, e.g., one or more layers.

In accordance with one or more embodiments, with the multi-layer experimentation platform, a user can be assigned a hash value in a given layer, and can be assigned to a bucket for an experiment in the layer using the user's hash value. By way of a non-limiting example, each layer can have a corresponding hash function and a unique random seed, which can be used to generate a hash value for a user in the layer. Using a unique random seed for each layer allows each user to have a different hash value for each layer. A hash value can be assigned to multiple users in a layer, and multiple hash values can be used in assigning users to a bucket associated with an experiment.

At step 406, which can be performed by user value generation module 302, a metric value can be obtained for each user and for each metric of interest. In accordance with one or more embodiments, for each user, a value for each of a number of metrics of interest can be obtained. Some non-limiting examples of metrics that can be used include number of days visited, number of page views, network sessions, and property-level revenue. Thus, for each user in a user pool (each of which can have a corresponding hash value), a value for each identified metric can be determined using data (e.g., historical data from database 320) associated with a given time period, e.g., the preceding number of days. Continuing with the example provided herein, each user can have a days-visited metric value, a page-views metric value, a network sessions metric value and/or a property-level metric value determined using data collected in the preceding number (e.g., 7) days. By way of a non-limiting example, a metric and its corresponding value can be a measure of a user's engagement with a web site, application, etc.

At step 408, which can be performed by user value generation module 302, a standardized (or normalized) metric value can be determined for each metric value obtained (at step 406) for each user. By way of a non-limiting example, the standardized (or normalized) metric value, for a user and a given metric value, can be determined using the metric value determined for the user, together with a mean and standard deviation determined across the pool of users.

By way of a non-limiting example, a standardized value can be determined for a given metric value by determining a mean and standard deviation and using the following expression:

$$Normalized MV = \frac{MV - μ}{σ} \qquad Expression ( 1 )$$

In Expression (1), Normalized MV represents a standardized value corresponding to a metric value, MV, μ represents a mean determined for the metric using the metric values of the users of the user pool, and σ represents the standard deviation determined using the mean, μ. By way of a further non-limiting example, the mean, μ, can be an average of the values (e.g., across the users) associated with a metric (e.g., time spent). The standard deviation, μ, can be determined using the following expression:

$$σ = \sqrt{\frac{1}{N} {\sum }_{i = 1}^{N} {( {MV}_{i} - μ )}^{2}} \qquad Expression ( 2 )$$

In Expression (2), σ represents the standard deviation, μ represents the mean, N represents the number of users, i represents a counter having a value corresponding to each user in the pool of users, MV is the value of a metric (e.g., time spent), and MVᵢ represents the i^{th} user's value for the metric, MV. As indicated by Expression (2), the standard deviation, σ, can be determined by taking the square root of the sum across all users of the squared difference, for each user, of the user's (e.g., the i^{th} user's) value of the metric (e.g., MVᵢ) and the mean, μ.

At step 410, which can be performed by matrix generation module 304, at least one aggregate standardized metric value is determined for each hash value in the hash value range. By way of a non-limiting example, assuming (for simplicity sake) that one metric is being used at steps 406 and 408. In such a case, one aggregate standardized metric value is determined for each hash value, and a hash value's aggregate standardized metric value can be an average of the standardized metric value determined for each user associated with the hash value. If multiple metrics are being used, each hash value can have an aggregate standardized metric value for each of the metrics.

At step 412, which can be performed by matrix generation module 304, a set of pairwise distances can be obtained. In accordance with at least one embodiment, the set of pairwise distances can be stored as a distance matrix M. By way of a non-limiting example, the distance matrix M can be a two-dimensional matrix with a number of rows and columns. In accordance with one or more embodiments, the number of rows and columns can be equal, or the same. By way of one non-limiting example, if the number of rows and columns is equal to 1000, the matrix M is a 1000×1000 matrix, and the range of hash values determined in the first step is 0-999. In accordance with one or more embodiments, multiple users can have the same hash value. For example, assuming there are 1,000,000 (one million) users in total and a 0-999 hash value range, each hash value in the hash value range can have 1000 users hashed to the hash value—1000 users can be assigned to each hash value in the hash value range.

While it is possible to control the number of users assigned to each hash value such that each hash value has exactly 1000 assigned users in the above example, it is not necessary to do so. In accordance with one or more embodiments, assuming the 0-999 hash value range in the above example, it is possible for one hash value to have more or less than 1000 users. A user that visits a website can have a 1/1000^{th} chance of being assigned to each of the values in the hash value range. If 1,000,000 (one million) users visit the website, each hash value can have 1000 users on average, such that it is possible for one hash value to have less than 1000 users (e.g., 998 users) and another hash value to have more than 1000 users (e.g., 1001 users).

In accordance with one or more embodiments, each cell in the matrix M has a corresponding pairwise distance associated with a pair of hash values, which can be determined using at least one aggregate standardized metric value associated with each hash value in the pair. For example, using i as a row index and j as a column index, an element Mᵢⱼ represents the pairwise distance (e.g., Euclidean distance) determined using the pair of aggregate standardized metric values associated with row i and column j in the matrix M. In accordance with one or more embodiments, the aggregate standardized metric value corresponding to row i (or column j) can be an average of the standardized metric values corresponding to the users associated with row i (or column j). For example, with respect to row i, the aggregate standardized metric value can be the average of the standardized metric values of the users associated with a hash value equal to i. Where hash value i and hash value j are equal indicating the set of users with the same hash value, the corresponding cell of the matrix M can have a value of zero for the pairwise distance.

In accordance with embodiments of the present disclosure, any number of metrics can be used in determining a pairwise distance for a pair of hash values. The following expression can be used to determine a pairwise distance as a Euclidean distance for a pair of hash values, H1 and H2, and a number, m, metrics:

$$e = \sqrt{\begin{matrix}{( {AV}_{1 , H 1} - {AV}_{1 , H 2} )}^{2} + {( {AV}_{2 , H 1} - {AV}_{2 , H 2} )}^{2} \\ + … + {( {AV}_{m , H 1} - {AV}_{m , H 2} )}^{2}\end{matrix}} \qquad Expression ( 3 )$$

In Expression (3), AV represents an aggregate standardized metric value determined (e.g., at step 410) for a metric (e.g., represented using a subscript, 1−m) associated with a hash value (e.g., H1 or H2) and e represents the pairwise distances as a Euclidean distance determined for the pair of hash values, H1 and H2. In the example, the number of metrics is represented as m, where m can be one or more metrics of interest. Where m is equal to 1, Expression (3) can be simplified to exclude the subexpressions after the first + sign, and where m is equal to 2, Expression (3) can be simplified to exclude the subexpression after the second + sign.

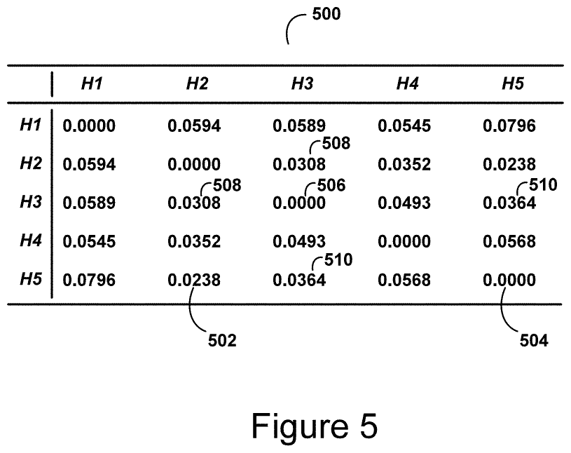

FIG. 5 provides a diagram of an exemplary example of a non-limiting embodiment in accordance with some embodiments of the present disclosure. In the example, a portion 500 of a matrix, M, is provided for illustration purposes. In the example, the column and row headings H1, H2, H3, H4 and H5 represent hash values in a hash value range. Each value shown in a cell of portion 500 of matrix, M, represents a pairwise distance between two hash values. For example, value 502 is a pairwise distance determined for hash values H5 and H2. Value 504 set at 0.0000 corresponds to the row and column that are both associated with the same hash value, H5, and therefore there is a zero pairwise difference. The pairwise distances in cells with row and column designations corresponding to one hash value (i.e., the same hash value) can be ignored when identifying hash values with the lowest pairwise distances for purposes of assigning a user to a bucket.

Referring again to FIG. 4, at step 414, which can be performed by bucket assignment module 306, the matrix M can be used to iteratively assign users from the set (or pool) of users to buckets until a determined bucket size (e.g., a certain percentage of users) is reached for each of a number of buckets (e.g., a requested number of buckets).

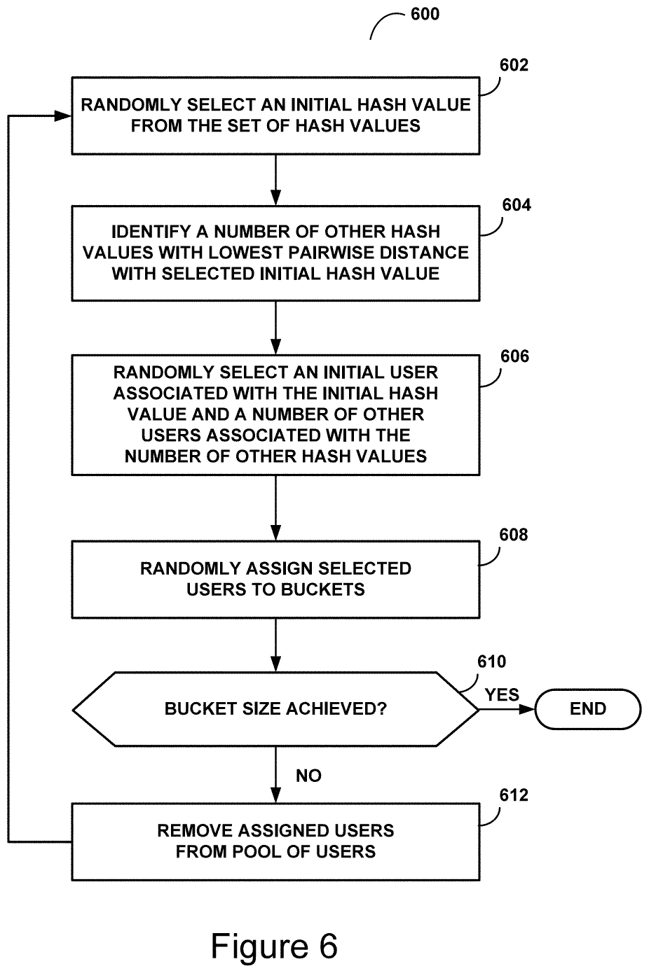

FIG. 6 provides a process flow overview in accordance with one or more embodiments of the present disclosure. Process 600 of FIG. 6 details steps (e.g., used in step 414 of FIG. 4) performed in accordance with exemplary embodiments of the present disclosure for automatically assigning and validating buckets using NNM (Nearest Neighbor Matching. According to some embodiments, as discussed herein with relation to FIG. 6, the process is performed iteratively to assign a predetermined number of users (e.g., a bucket size indicated in the request received at step 402 of FIG. 4, a system parameter, etc.) to a number, n, buckets (e.g., indicated in the request received at step 402 of FIG. 4, a system parameter, etc.) in accordance with pairwise distances determined using a number of metrics associated with each user in the pool of users.

In accordance with one or more embodiments, such assignment and validation involves randomly selecting an initial hash value, randomly selecting an initial user associated with the initial hash value, identifying (e.g., using matrix M) n−1 other hash values having the lowest pairwise distance with the initial hash value relative to the pairwise distances of other unselected hash values, and randomly selecting n−1 other users each being associated with one of the n−1 other hash values. Each user in a set of identified users comprising a number, n, users including the initial user (associated with the initial hash value) and n−1 other users associated with the n−1 other hash values can then be randomly assigned to the a bucket, such that the initial user and the n−1 other users are assigned to one of the number, n, buckets, as discussed in more detail below.

At step 602, which can be a first step in a current bucket assignment iteration, an initial hash value in the range of hash values can be randomly selected.

At step 604, other hash values in the range of hash values can be selected using the pairwise distances determined for the initial hash value (e.g., the initial hash value's pairwise distances from matrix M). Each of the initial hash value's pairwise distances considered at this step indicates a distance between the initial hash value and each other hash value in the range of hash values. In accordance with one or more embodiments, the pairwise distances associated with the initial hash value are used to identify a number of other hash values, each of which has a lower pairwise distance (as compared with the pairwise distance of each other unselected hash value). By way of a non-limiting example, assuming that the number of buckets to which users are being assigned is equal to three, the two lowest pairwise distances associated with the initial hash value can be identified.

Referring again to FIG. 5, assume that hash value H3 is selected as the initial hash value (at step 602 of FIG. 6) and that the number of buckets is equal to 3. Excluding pairwise distance 506 (which corresponds to the initial hash value), pairwise distances 508 and 510 are the lowest pairwise distances in the row (or column) corresponding to the initial hash value, H3. Pairwise distances 508 and 510 correspond to hash values H2 and H5, respectively.

Referring again to FIG. 6, at step 606, a user (e.g., an initial user) associated with the initial hash value (e.g., H3) identified at step 602 is selected along with a user from each of the other hash values (e.g., H2 and H5) identified at step 604. Continuing with the non-limiting example discussed above in which the number of buckets is equal to 3, the initial user and two other users are selected at step 606. In this example, an initial user corresponding to the initial hash value H3 and two other users corresponding to hash values H2 and H5 can be selected for inclusion in the set of identified users at step 606 of FIG. 6.

At step 608, the users included in the set of identified users selected at step 606 can each be assigned (e.g., randomly assigned) to one of the buckets (e.g., one of the three buckets in the above example). By way of a non-limiting example and continuing with the example discussed above, the users represented by hash values H2, H3 and H5 can each be randomly assigned to one of the three buckets—e.g., the initial user associated with initial hash value H2 can be assigned to bucket number 3, the user associated with hash value H3 can be assigned to bucket number 1 and the user associated with hash value H5 can be assigned to bucket number 2.

In accordance with one or more embodiments, the bucket can be randomly selected and the user that is assigned to the randomly-selected bucket can be randomly selected from the set of identified users. In accordance with one or more embodiments, after a bucket is assigned a user, it is excluded from user assignment in the current iteration, and after a user is assigned to a bucket in the current iteration the user is excluded from subsequent bucket assignment iterations. That is, each user assigned to a bucket in the current bucket assignment iteration becomes unavailable (e.g., an unavailable user from the user pool) in subsequent bucket assignment iterations in connection with the current bucket assignment request.

The bucket assignment and validation can continue iteratively in this manner until a predetermined bucket size is reached for each bucket. Thus, at step 610, a determination is made whether or not the desired bucket size (e.g., the bucket side indicated in the bucket assignment and validation request received at step 402 by the BAV engine 300) has been achieved, or reached.

If not, processing can continue at step 612 to remove each user assigned to a bucket in the current bucket assignment iteration from the user pool before processing continues at 602 to repeat steps 602, 604, 606 and 608 to identify another initial hash value and other hash values and corresponding initial and other users for assignment to the set of buckets, as discussed herein.

If it is determined, at step 610, that the desired bucket size is reached, processing can continue at step 416, which can be performed by bucket communication module 308, to communicate the bucket assignments to the requester. The bucket assignments can then be used in a bucket experiment.

The automatic A/A validation using a Nearest Neighbor Matching (NNM) disclosed herein improves bucket balance, or A/A balance, and reduces the false positive rate for the metrics of interest. Automatic bucket validation using a Nearest Neighbor Matching (NNM) approach disclosed herein improves over prior approaches. Embodiments of the present disclosure provide a balanced approach for assigning users to buckets for use in bucket experiments. Embodiments of the present disclosure provide a mechanism for balancing bucket assignments and validating matches among users being assigned to buckets as the users are being assigned to the buckets.

Since there is no need to perform A/A testing, the automatic bucket validation using NNM saves significant time and effort over A/A testing. In addition, the automatic bucket validation using NNM disclosed herein can be used with any number of metrics whose values (e.g., standardized values) can be aggregated into a Euclidean distance to measure pairwise distance between the metric values determined for a pair of users. Use of pairwise distances facilitates bucket balancing. In addition, the approach can be used regardless of the number of metrics identified for a given experiment as the disclosed approach eliminates the need for discarding users with extreme metric values (which results in an unwanted reduction in the user pool).

It will be recognized from the disclosure herein that embodiments of the instant disclosure provide improvements to a number of technology areas, for example those related to systems and processes that provide user interface displays, including online and application user interface displays. By way of some non-limiting examples, systems and processor can use user interface displays to display content, distribute content, provide recommendations, provide search engine results, etc. The disclosed systems and methods can effectuate increased speed and efficiency in the ways that experimentation buckets can be provided for use in testing efficacies related to different user interface display options, as the disclosed systems and methods, inter alia, automatically assign users to buckets using a NNM methodology. Users are assigned a hash value, a set of standardized metric values is used to determine pairwise distance between each user pair using each user's set of standardized metric, and an iterative approach is used to make bucket assignment based on pairwise distances determined for the users.

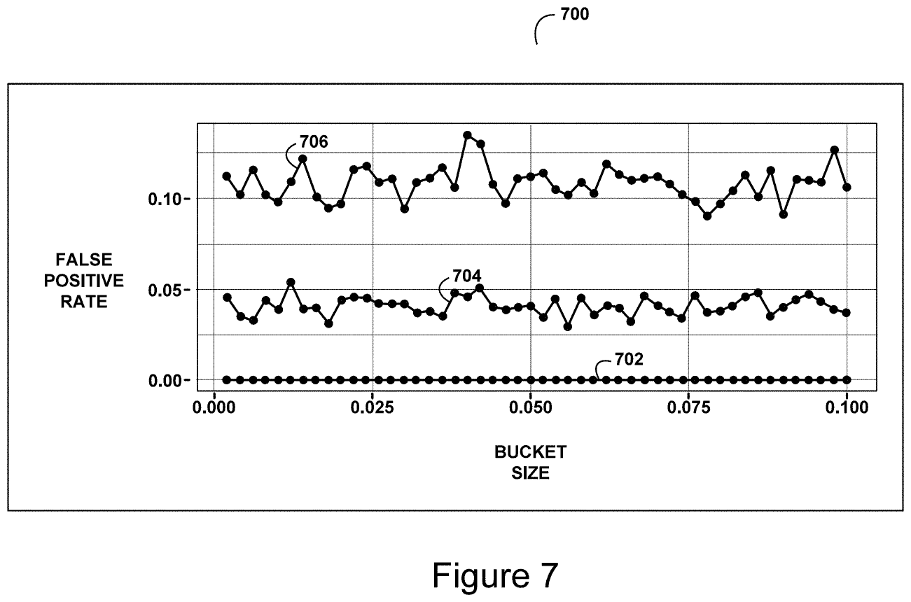

FIG. 7 provides an exemplary example of a simulation in accordance with one or more embodiments. By way of a non-limiting example, given a null hypothesis, a false positive might occur when a true null hypothesis is rejected. A false positive rate is one example of a mechanism that can be used in evaluating bucket quality and the mechanism used in generating the buckets.

Example 700 illustrates a false positive rate associated with three different bucket assignment approaches. The example 700 was obtain by simulating 100 bucket pairs for three different bucket assignment approaches. Line graph 702 shows false positive rates in connection with a pair of buckets to which users were assigned using embodiments disclosed herein. Line graph 704 shows false positive rates in connection with a ready-to-use A/A methodology. Line graph 706 shows false positive rates in connection with random bucket assignment approach in which users are randomly assigned to one of the pair of buckets.

The false positive rates were collected by simulating 1000 bucket pairs for each one of the three approaches using one metric (e.g., classic page views, or CPVs). For each bucket pair, one hypothesis test was carried out, and the false positive rate of the 1000 bucket pairs was determined by the percentage of failure tests. A comparison was performed for various buckets sizes, as shown in the example 700.

From the example 700, it can be seen that the random selection method (corresponding to line graph 706) has the worst positive with the highest false positive rates regardless of bucket size. Line graph 706 shows that more than 100 tests out of 1000 regardless of bucket size. As discussed herein, these high false positive rates effectively render the outcome of a bucket experiment questionable.

In comparison to the random selection method, the ready-to-use A/A methodology has performance improvements. As shown in connection with line graph 704, the ready-to-use A/A methodology effectively reduces the false positive rates to below 5%. This is still a rather high false positive rate and can result in A/A imbalances and inaccurate bucket experiment results.

As shown with reference to line graph 702, the bucket assignment and validation approach disclosed herein provides much improved performance over the other two approaches in the example 700. The false positive rate is decreased to 0%, which rate is consistent regardless of bucket size. These findings indicate that the automatic bucket assignment and validation using NNM provide a solution to the A/A imbalance issue, and significantly improve over prior approaches.

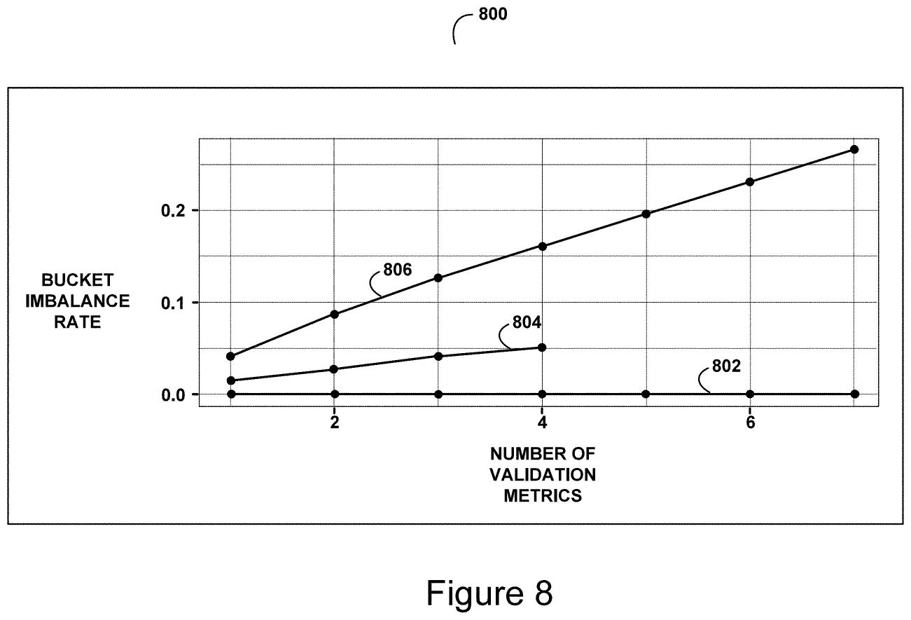

Additionally, the disclosed automatic bucket assignment using NNM addresses a multiple metric comparison issue that occurs when multiple metrics are used in an experiment. By way of a non-limiting example, the multiple metrics can be used in selecting a pool of users (e.g., as with the ready-to-use A/A methodology) and in assessing the validity of the results of a bucket experiment. By way of a further non-limiting example, one metric for assessing the validity of the results of a bucket experiment is bucket rate imbalance. FIG. 8 provides an exemplary example of a simulation in accordance with one or more embodiments. Example 800 demonstrates that the bucket assignment and validation using NNM provides the ability to expand the number of metrics without experiencing performance loss.

Example 800 illustrates a bucket imbalance rate associated with the same three bucket assignment approaches used in example 700 of FIG. 7. In the example 800, line graph 802 shows bucket imbalance rates in connection with different number of metrics in connection with bucket assignments made using the bucket assignment and validation using NNM approach disclosed herein. Line graph 704 shows bucket imbalance rates in connection with the ready-to-use A/A methodology. Line graph 706 shows bucket imbalance rates in connection with the random bucket assignment approach in which users are randomly assigned to one of the pair of buckets.

The bucket imbalance rates were collected by simulating 1000 bucket pairs for each one of the three approaches using a different number of metrics—1 to 7 metrics. For each number of metrics, 1000 bucket pairs were simulated and an average bucket imbalance rate was determined. For the example 800, a bucket pair was identified as being imbalanced if any of the validation metrics was significantly different.

From the example 700, it can be seen that bucket assignment and validation with NNM disclosed herein significantly outperforms the random-selection and ready-to-use A/A methodology and has no performance loss as the number of validation metrics increases.

The ready-to-use A/A methodology approach had difficulty expanding beyond 4 metrics due to the tail hash value removal (i.e., removal of users with extreme metric values) discussed herein. This difficulty is shown by the truncation of line graph 804 at 4 metrics.

Referring again to FIG. 4 and in accordance one or more embodiments of the present disclosure, a number of the steps can be performed offline, e.g., independent of a bucket assignment request. For example steps 404, 406, 408 and 410 can be performed offline.

In accordance with one or more embodiments, the distance matrix M can be refreshed periodically (e.g., daily) for bucket assignment and validation using NNM.

Advantageously, a bucket assignment and validation requester (e.g., an entity wishing to conduct a bucket experiment) can make a request (e.g., at step 402 of FIG. 4) and the requested bucket assignments can be returned to the requester (e.g., at step 414 of FIG. 4) virtually instantaneous thereby making a set of buckets immediately available and ready for a bucket experiment without the need for A/A validation.

Embodiments of the present disclosure provide mechanisms for addressing issues associated with the size of the pairwise distance matrix M. For example, with a hash range of [0, 999], the pairwise distance matrix has a size of one million data points (1000×1000). In a multi-layer experimentation platform, each layer can have a pairwise distance matric M, and the multi-layer experimentation platform can comprise hundreds of layers at any given time. Each pairwise distance matric M can be kept in RAM. Alternatively, a pairwise distance matrix can be stored on disk, and read from disk and stored in RAM as needed. The latter approach can result in some delay and disk reads would likely occur each time the pairwise distance matrix M is needed to perform the NNM.

In accordance with one or more embodiments, a hybrid approach can be used to address a size issue associated with the pairwise distances matrices. According to the hybrid approach, a pairwise distance matrix M can be predetermined for each layer and stored on disk, or other non-transitory storage. As discussed herein, each distance matrix M can be determined daily using historical metric value data corresponding to a time window (e.g., historical metric value data for the preceding seven days).

Continuing with the hybrid approach, a number (e.g., 100) hash values (or users) can be randomly selected and a subset of each pairwise distance matrix M corresponding to the randomly-selected hash values can be retrieved from non-transitory storage (e.g., disk storage) and placed in transitory storage (e.g., RAM). Using 100 as the number of randomly-selected hash values, ten thousand data points can be stored in non-transitory storage for NNM matching during bucket assignment. As bucket assignments occur, the number of randomly-selected hash values is reduced. When the number of remaining randomly-selected hash values falls below some threshold number of remaining randomly-selected hash values (e.g., 50), another 100 hash values can be randomly selected and the corresponding portion of the pairwise distance matrix M can be read from non-transitory storage and stored in transitory storage.

With the hybrid approach, the amount of transitory (e.g., RAM) space is reduced. Using the above example, the reduction is from one million data points to ten thousand, which amount to a mere 1% of the need without the hybrid approach. In addition, the number of disk reads is reduced. Using the above example, a pairwise distance matrix M is only read from the disk 20 times at most for an individual layer by setting the threshold as 50, which does not slow down the processing speed much.

As discussed herein, online controlled experiments play an essential role in the research and development cycles of many companies. It has been long accepted as the gold standard in establishing the causal link between the product features and the amount of metrics' changes. Embodiments of the present disclosure provide a novel bucket assignment and validation framework for bucket experimentation used in online experimentation. The novel approach disclosed herein eliminates the need for any A/A validation before an A/B phase and guarantees the A/A balance with high confidence. The novel approach disclosed herein minimizes the false positive rate for the A/A buckets, and expands the A/A validation to more metrics without causing the multiple comparison issues. As shown by the simulation testing discussed herein in connection with FIGS. 7 and 8, automatic assignment and validation using NNM disclosed herein outperforms the baselines.

In addition, disclosed embodiments makes more users available for inclusion in the bucket testing. As discussed herein, the ready-to-use A/A methodology removes users with extreme metric values in order to achieve lower imbalance rates. However, this approach shrinks the number of users (e.g., or traffic where the user are considered to be traffic to a website, application etc.) available for experimentation. The automatic bucket assignment and validation using NNM disclosed herein consistently provides significantly lower bucket imbalance rates and lower false positive rates than the ready-to-use A/A methodology without incurring any waste in a user pool (or user traffic).

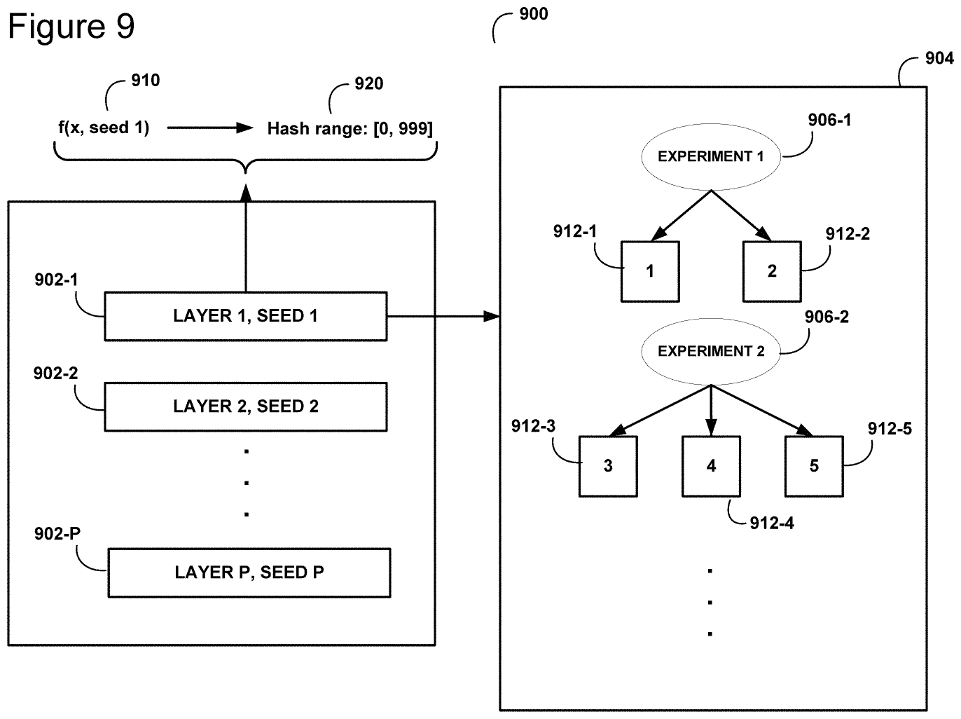

FIG. 9 provides an exemplary example of a multi-layer experimentation platform using bucket assignment and validation in accordance with one or more embodiments of the present disclosure. In accordance with one or more embodiments, a multi-layer experiment platform can comprise a number of layers, p. In the example, each instance 902-1, 902-2 . . . 902-P corresponds to an experiment layer in the multi-layer experimentation platform and a seed. For example, layer 902-1 corresponds to Layer 1 and Seed 1.

In accordance with one or more embodiments, each user can be assigned a hash value (e.g., an integer value) in a range of integers, such as and without limitation a range of 0 to 999 (or [0, 999]), and a one to one relationship between a user and a hash value can be used in a given layer, such that one user has only one hash value in a layer. A layer can cover an entire range of hash values, and the buckets and experiments on the same layer can be mutually exclusive. Each layer can be orthogonal to the other layers such that a user will always be assigned the same hash value using a layer's hash function and seed value, but can be assigned a different hash value in a different layer using that layer's hash function and seed. Since users can be reshuffled (e.g., assigned a different hash value) in each layer, the testing capability of the multi-layer experimentation platform is expansive.

In FIG. 9, a multi-layer platform experimentation platform 900 includes p layers, 902-1, 902-2, . . . 902-P, which can be collectively referred to as layers 902. A seed value associated with each layer (e.g., seed 1, seed 2, . . . , seed P) can be used with a hash function to generate a range of hash values. In the example 900, hash function 910 uses a user identifier, x, for each user and a seed value for the layer (e.g., seed 1 for layer 1) to generate a hash range 920 comprising a set of hash values corresponding to a pool of users. Hash function 910 can be used with a seed value for a given layer in the example 900 to generate a hash range 920 for the given layer and pool of users, where the hash value assigned to a user in the pool and given layer can be different than with other ones of the layers 902.

In accordance with one or more embodiments, a set of experiments 904 can be implemented in layer 902-1 using buckets of users assigned to the buckets using BAV engine 300. In the example of FIG. 9, experiments 906-1 and 906-2 each have a set of buckets of users assigned thereto. As shown in the example, each experiment can differ in the number of buckets.

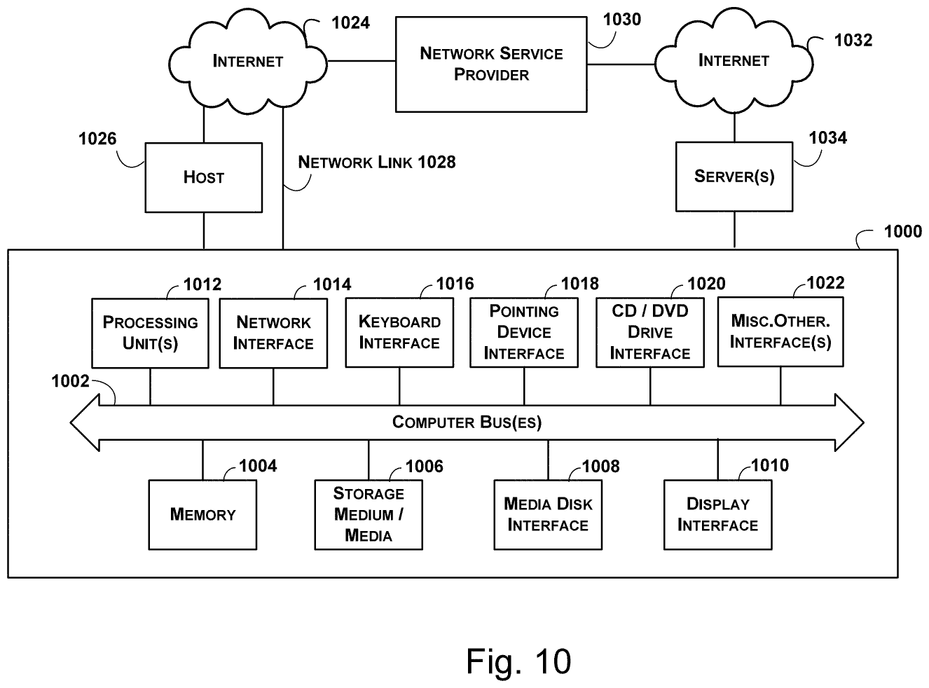

As shown in FIG. 10, internal architecture 1000 of a computing device(s), computing system, computing platform, user devices, set-top box, smart TV and the like includes one or more processing units, processors, or processing cores, (also referred to herein as CPUs) 1012, which interface with at least one computer bus 1002. Also interfacing with computer bus 1002 are computer-readable medium, or media, 1006, network interface 1014, memory 1004, e.g., random access memory (RAM), run-time transient memory, read only memory (ROM), media disk drive interface 1020 as an interface for a drive that can read and/or write to media, display interface 1010 as interface for a monitor or other display device, keyboard interface 1016 as interface for a keyboard, pointing device interface 1018 as an interface for a mouse or other pointing device, and miscellaneous other interfaces not shown individually, such as parallel and serial port interfaces and a universal serial bus (USB) interface.

Memory 1004 interfaces with computer bus 1002 so as to provide information stored in memory 1004 to CPU 1012 during execution of software programs such as an operating system, application programs, device drivers, and software modules that comprise program code, and/or computer executable process steps, incorporating functionality described herein, e.g., one or more of process flows described herein. CPU 1012 first loads computer executable process steps from storage, e.g., memory 1004, computer readable storage medium/media 1006, removable media drive, and/or other storage device. CPU 1012 can then execute the stored process steps in order to execute the loaded computer-executable process steps. Stored data, e.g., data stored by a storage device, can be accessed by CPU 1012 during the execution of computer-executable process steps.

Persistent storage, e.g., medium/media 1006, can be used to store an operating system and one or more application programs. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 1028 typically provides information communication using transmission media through one or more networks to other devices that use or process the information. For example, network link 1028 may provide a connection through local network 1024 to a host computer 1026 or to equipment operated by a Network or Internet Service Provider (ISP) 1030. ISP equipment in turn provides data communication services through the public, worldwide packet-switching communication network of networks now commonly referred to as the Internet 1032.

A computer called a server host 1034 connected to the Internet 1032 hosts a process that provides a service in response to information received over the Internet 1032. For example, server host 1034 hosts a process that provides information representing video data for presentation at display 1010. It is contemplated that the components of system 1000 can be deployed in various configurations within other computer systems, e.g., host and server.

At least some embodiments of the present disclosure are related to the use of computer system 1000 for implementing some or all of the techniques described herein. According to one embodiment, those techniques are performed by computer system 1000 in response to processing unit 1012 executing one or more sequences of one or more processor instructions contained in memory 1004. Such instructions, also called computer instructions, software and program code, may be read into memory 1004 from another computer-readable medium 1006 such as storage device or network link. Execution of the sequences of instructions contained in memory 1004 causes processing unit 1012 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 1000. Computer system 1000 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 1002 as it is received, or may be stored in memory 1004 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
receiving, at a computing device and from a requester, a bucket assignment request for a set of buckets to be used in a bucket experiment;
associating, via the computing device, each user in a user pool with a hash value of a range of hash values;
obtaining, via the computing device, a metric value for each user in the user pool;
determining, via the computing device, an aggregate metric value for each hash value in the range of hash values, a respective hash value's aggregate metric value being determined using the metric value obtained for each user associated with the respective hash value;
obtaining, via the computing device, a set of pairwise distances, each pairwise distance of the set corresponding to a pair of hash values in the range of hash values, the pairwise distance for the pair of hash values being determined using the aggregate metric values determined for the pair of hash values;
determining, via the computing device, user assignments for the set of buckets by assigning a number of users from the user pool to the set of buckets in each of a number of bucket assignment iterations, each bucket assignment iteration comprising:
randomly selecting, via the computing device, an initial hash value in the range of hash values;
selecting, via the computing device and in the range of hash values, a set of hash values other than the initial hash value using the pairwise distances associated with the initial hash value, each hash value in the set of hash values having an associated pairwise distance with the initial hash value that is less than any unselected pairwise distance associated with the initial hash value;
randomly selecting, via the computing device, an initial user associated with the initial hash value for inclusion in a set of identified users;
randomly selecting, via the computing device, a user associated with each hash value from the set of hash values for inclusion in the set of identified users;
randomly assigning, via the computing device, one user from the set of identified users to each bucket of the number of buckets; and
removing, via the computing device, the set of identified users from the user pool for any remaining bucket assignment iterations; and
providing, via the computing device, the number of buckets to the requester, each bucket of the number having a unique set of users selected from the user pool.

2. The method of claim 1, the obtaining further comprising:
generating, via the computing device, a pairwise distance matrix comprising a number of rows and a number of columns, each hash value in the range of hash values having a corresponding row and column in the pairwise distance matrix, and each cell comprising a pairwise distance determined for a first hash value corresponding to a designated row and a second hash value corresponding to a designated column.

3. The method of claim 2, further comprising:
selecting either a row or column in the matrix corresponding to the initial hash value;
selecting a number of cells each with a closer pairwise distance than the pairwise distances of other unselected cells in the selected row or column, each selected cell associated with the initial hash value and another hash value in the range of hash values; and
identifying, for each selected cell in the number, one user from the user pool associated with the cell.

4. The method of claim 1, determining the respective hash value's aggregate metric value further comprising:
determining a standardized metric value for each user using a mean and standard deviation determined using the metric value of each user in the user pool; and
using the standardized metric value determined for each user associated with the respective hash value in determining the respective hash value's aggregate metric value.

5. The method of claim 1, the bucket assignment request comprising a number of buckets in the set of buckets and a bucket size for each bucket of the set.

6. The method of claim 1, the metric value is a page views metric and the respective hash value's aggregate metric value is an aggregate of the page views metric value of the page views metric for each user associated with the respective hash value.

7. The method of claim 1, associating each user in the user pool with a hash value in the range of hash values further comprising:
generating, via the computing device, a hash value for each user of the user pool using a hash function and a seed value.

8. The method of claim 7, the number of buckets provided to the requester being for an experiment in a layer of a multi-layer experimentation platform.

9. The method of claim 8, generating a hash value further comprising:
using a hash function and a seed value corresponding to the layer to generate the hash value for each user.

10. The method of claim 9, each layer of the multi-layer experimentation platform having a corresponding hash function and seed value that is unique to the layer, such that a user's hash value is different for each layer of the multi-layer experimentation platform.

11. A non-transitory computer-readable storage medium tangibly encoded with computer-executable instructions that when executed by a processor associated with a computing device perform a method comprising:
receiving, from a requester, a bucket assignment request for a set of buckets to be used in a bucket experiment;
associating each user in a user pool with a hash value of a range of hash values;
obtaining a metric value for each user in the user pool;
determining an aggregate metric value for each hash value in the range of hash values, a respective hash value's aggregate metric value being determined using the metric value obtained for each user associated with the respective hash value;
obtaining a set of pairwise distances, each pairwise distance of the set corresponding to a pair of hash values in the range of hash values, the pairwise distance for the pair of hash values being determined using the aggregate metric values determined for the pair of hash values;
determining user assignments for the set of buckets by assigning a number of users from the user pool to the set of buckets in each of a number of bucket assignment iterations, each bucket assignment iteration comprising:
randomly selecting an initial hash value in the range of hash values;
selecting, in the range of hash values, a set of hash values other than the initial hash value using the pairwise distances associated with the initial hash value, each hash value in the set of hash values having an associated pairwise distance with the initial hash value that is less than any unselected pairwise distance associated with the initial hash value;
randomly selecting an initial user associated with the initial hash value for inclusion in a set of identified users;
randomly selecting a user associated with each hash value from the set of hash values for inclusion in the set of identified users;
randomly assigning one user from the set of identified users to each bucket of the number of buckets; and
removing the set of identified users from the user pool for any remaining bucket assignment iterations; and
providing the number of buckets to the requester, each bucket of the number having a unique set of users selected from the user pool.

12. The non-transitory computer-readable storage medium of claim 11, the obtaining further comprising:
generating, via the computing device, a pairwise distance matrix comprising a number of rows and a number of columns, each hash value in the range of hash values having a corresponding row and column in the pairwise distance matrix, and each cell comprising a pairwise distance determined for a first hash value corresponding to a designated row and a second hash value corresponding to a designated column.

13. The non-transitory computer-readable storage medium of claim 12, the method further comprising:
selecting either a row or column corresponding to the initial user in the matrix;
selecting a number of cells each with a closer pairwise distance than the pairwise distances of other unselected cells in the selected row or column, each selected cell associated with the initial hash value and another hash value in the range of hash values; and
identifying, for each selected cell in the number, one user from the user pool associated with the cell.

14. The non-transitory computer-readable storage medium of claim 11, determining the respective hash value's aggregate metric value further comprising:
determining a standardized metric value for each user using a mean and standard deviation determined using the metric value associated with each user in the user pool; and
using the standardized metric value determined for each user associated with the respective hash value in determining the respective hash value's aggregate metric value.

15. The non-transitory computer-readable storage medium of claim 11, the metric value is a page views metric and the respective hash value's aggregate metric value is an aggregate of the page views metric value of the page views metric for each user associated with the respective hash value.

16. The non-transitory computer-readable storage medium of claim 11, associating each user in the user pool with a hash value in the range of hash values further comprising:
generating a hash value for each user of the user pool using a hash function and a seed value.

17. The non-transitory computer-readable storage medium of claim 16, the number of buckets provided to the requester being for an experiment in a layer of a multi-layer experimentation platform.

18. The non-transitory computer-readable storage medium of claim 17, generating a hash value further comprising:
using a hash function and a seed value corresponding to the layer to generate the hash value for each user.

19. The non-transitory computer-readable storage medium of claim 18, each layer of the multi-layer experimentation platform having a corresponding hash function and seed value that is unique to the layer, such that a user's hash value is different for each layer of the multi-layer experimentation platform.

20. A computing device comprising:
a processor;
a non-transitory storage medium for tangibly storing thereon program logic for execution by the processor, the program logic comprising:
logic executed by the processor for
receiving, from a requester, a bucket assignment request for a set of buckets to be used in a bucket experiment;
associating each user in a user pool with a hash value of a range of hash values;
obtaining a metric value for each user in the user pool;
determining an aggregate metric value for each hash value in the range of hash values, a respective hash value's aggregate metric value being determined using the metric value obtained for each user associated with the respective hash value;
obtaining a set of pairwise distances, each pairwise distance of the set corresponding to a pair of hash values in the range of hash values, the pairwise distance for the pair of hash values being determined using the aggregate metric values determined for the pair of hash values;
determining user assignments for the set of buckets by assigning a number of users from the user pool to the set of buckets in each of a number of bucket assignment iterations, each bucket assignment iteration comprising:
randomly selecting an initial hash value in the range of hash values;
selecting, in the range of hash values, a set of hash values other than the initial hash value using the pairwise distances associated with the initial hash value, each hash value in the set of hash values having an associated pairwise distance with the initial hash value that is less than any unselected pairwise distance associated with the initial hash value;
randomly selecting an initial user associated with the initial hash value for inclusion in a set of identified users;
randomly selecting a user associated with each hash value from the set of hash values for inclusion in the set of identified users;
randomly assigning one user from the set of identified users to each bucket of the number of buckets; and
removing the set of identified users from the user pool for any remaining bucket assignment iterations; and
providing the number of buckets to the requester, each bucket of the number having a unique set of users selected from the user pool.
